(19) United States
(12) Patent Application Publication
(10) Pub. No.: US 2024/0359913 A1
(43) Pub. Date: Oct. 31, 2024

(54) WASTE COLLECTION SYSTEM WITH RECIPROCATING PACKING DEVICE

(71) Applicant: The Heil Co., Chattanooga, TN (US)

(72) Inventors: Michael Shane Peek, Pisgah, AL (US); Marc Nadeau, Levis (CA); Michel Fillion, Beaumont (CA); Phillip A. Kendrick, Chattanooga, TN (US)

(21) Appl. No.: 18/644,358

(22) Filed: Apr. 24, 2024

Related U.S. Application Data
(60) Provisional application No. 63/462,955, filed on Apr. 28, 2023.

(51) Int. Cl. B65F 3/20; B65F 3/14

(52) U.S. Cl. CPC B65F 3/201; B65F 3/143

(57) ABSTRACT

A waste packing device includes a chute, a packer blade, a rod, and a drive unit. The chute includes an opening. The packer blade is configured to translate back and forth in the chute. The rod is pivotally coupled to the packer blade. The drive unit is pivotally coupled to the rod and operable to move the packer blade back and forth in the chute to push waste through the opening of the chute.

### CROSS REFERENCE TO RELATED APPLICATION

This application claims the benefit under 35 U.S.C. § 119(e) of U.S. Patent Application No. 63/462,955, entitled “Waste Collection System with Reciprocating Packing Device,” filed Apr. 28, 2023, which is incorporated herein by reference in its entirety.

### BACKGROUND

Refuse collection vehicles (“RCVs”) often include packing mechanisms for compacting and ejecting refuse material. The forces required to effectively pack the large quantities of refuse are substantial. To meet the demands of this application, ejector panels used to pack the material are often driven using telescopic hydraulic cylinders. Although hydraulic cylinders are well-suited to supply the forces needed to achieve packing, the use of hydraulic cylinders in a refuse application comes with high maintenance costs. The potential for contamination of the hydraulic fluid, for example, results in frequent maintenance intervals, vehicle down-time, and sometimes costly repairs.

Some refuse vehicles use an auger mechanism to compact refuse. In some auger systems, refuse that has been dropped into a hopper is advanced by a rotating auger screw to push and compact refuse into a compartment at the rear of the vehicle. This compacted refuse must then be ejected from the vehicle.

### SUMMARY

Implementations of the present disclosure are generally directed to systems and methods for packing refuse and ejecting refuse from an RCV.

In a general aspect of the disclosure, a waste packing device includes a chute, a packer blade, a rod, and a drive unit. The chute includes an opening. The packer blade is configured to translate back and forth in the chute. The rod is pivotally coupled to the packer blade. The drive unit is pivotally coupled to the rod and operable to move the packer blade back and forth in the chute to push waste through the opening of the chute.

In some implementations, the packer blade is operable to advance waste from the chute into a container for receiving waste.

In some implementations, the waste packing device further includes a hopper configured to direct waste onto the packer blade.

In some implementations, the packer blade is configured to extend beyond the chute.

In some implementations, the chute includes a curved bottom portion or a square bottom portion.

In some implementations, the rod includes a first end and a second end, the first end of the rod is coupled to the packer blade and the second end of the rod is coupled to the drive unit.

In some implementations, the drive unit includes a rotating component and an electric motor coupled to the rotating component.

In some implementations, the drive unit includes a rotating component one end of the rod is pivotally coupled to the rotating component at a pivot point offset from a rotation axis of the rotating component.

In some implementations, the drive unit includes a drive motor, and a rotating component pivotally coupled to a first end of the rod. A drive chain is operably coupled between the motor and rotating component. The motor is operable to turn the rotating component to move the packer blade back and forth in the chute.

In some implementations, the waste packing device further includes a controller coupled to the drive unit. The controller is operable to control the drive unit to move the packer blade forward and back in the chute.

In some implementations, the controller is configured to control the motor to selectively hold the packer blade in a fixed position in the chute.

In some implementations, the controller is configured to control the motor to hold the packer blade a forward-most position in the chute.

In some implementations, the waste packing device further includes a brake configured to hold the packer blade in a selected position in the chute.

In some implementations, the brake is a motor brake.

In some implementations, the waste packing device further includes a brake configured to hold the packer blade in a selected position in the chute; and a controller coupled to the brake and configured to apply the brake to hold the packer blade in a selected position in the chute.

In some implementations, the packer blade includes a leading portion including a leading end; and a trailing portion. The leading portion includes a sloping nose section configured to direct waste toward the leading end of the packer blade.

In some implementations, the waste packing device further includes one or more guide rails. The packer blade is slidably coupled to at least one of the one or more guide rails. The one or more guide rails include a pair of opposing guide rails. The packer blade is slidably coupled between the pair of opposing guide rails.

In some implementations, the waste packing device further includes a container configured to receive waste pushed through the chute by the packer blade, and an ejector panel configured to push waste out of the container.

In another general aspect of the disclosure, a vehicle for collecting waste includes a frame and a waste collecting device secured to the frame. The waste collecting device includes a container and a packing device. The container encloses a waste receiving volume. The packing device is coupled to the container. The packing device includes a packer blade configured to translate back and forth, a rod pivotally coupled to the packer blade, a drive unit pivotally coupled to the rod and operable to move the packer blade back and forth to push waste into the waste receiving volume.

In some implementations, the vehicle further includes a hopper configured to direct waste onto the packer blade.

In some implementations, the vehicle further includes a chute. The packer blade is configured to translate back and forth in the chute to push waste through an opening in the chute into the waste receiving volume.

In some implementations, the container includes a first end and a second end spaced apart from the first end along a longitudinal axis, an end wall located at the first end, an ejector panel located at the second end. The waste receiving volume is defined by a space between the end wall and the ejector panel. The ejector panel is configured to push waste through and out of the waste receiving volume during an unloading sequence by moving along the longitudinal axis between the first and second ends within the waste receiving volume and relative to a floor of the container.

In some implementations, the vehicle further includes a blocking device coupled to the ejector panel and configured to move along a direction perpendicular to the longitudinal axis between a first position, in which the blocking device inhibits waste in the waste receiving volume from entering the opening as the ejector panel moves along the longitudinal axis, and a second position, in which waste is uninhibited from entering the waste receiving volume through the opening.

In another general aspect of the disclosure, a method of packing waste includes receiving waste onto a packer blade; and moving the packer blade forward and back to push the waste into a waste receiving container.

In some implementations, moving the packer blade includes moving the packer blade forward and back within a chute.

In some implementations, moving the packer blade includes operating an electric motor to turn a rotating component coupled to packer blade.

In some implementations, the method further includes taking one or more measurements relating to the motion of the packer blade, and in response to at least one of the one or more measurements, controlling one or more operating parameters of the packer blade.

In some implementations, controlling at least one of the operating parameters includes controlling a speed of the packer blade.

In some implementations, controlling at least one of the operating parameters includes controlling a speed of an electric motor.

In some implementations, controlling at least one of the operating parameters includes controlling a position of the packer blade.

In some implementations, controlling at least one of the operating parameters includes controlling an angular position of a rotating component coupled to the packer blade.

In some implementations, taking one or more measurements includes measuring a torque of a drive component for the packer blade.

In some implementations, taking one or more measurements includes measuring a position of the packer blade or the position of one or more components coupled to the packer blade.

In some implementations, the method further includes, in response to one or more measurements, stopping the packer blade.

In some implementations, the method further includes applying a brake to inhibit motion of the packer blade.

In some implementations, controlling at least one of the operating parameters includes applying a constant torque to a drive rotating component.

Particular implementations of the subject matter described in this specification can be implemented so as to realize one or more of the following advantages.

Implementations of the present disclosure may making packing and ejection of waste more energy-efficient.

Implementations of the present disclosure may reduce the need for expensive, complex components with high maintenance costs.

Implementations of the present disclosure may reduce a risk of a waste collection system getting blocked up, stuck, or disabled.

Implementations of the present disclosure may increase effectiveness of packing and ejecting material in a waste collection system.

Implementations of the present disclosure may allow a waste collection system to collect more materials.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a refuse vehicle that includes a reciprocating packing device according to some implementations.

FIG. 2 is a rear perspective view of the waste intake portion of a waste collection device according to some implementations.

FIG. 3 is a front perspective view of the waste intake portion of a waste collection device according to some implementations.

FIG. 3A is a schematic rear view of a chute having a square bottom according to some implementations.

FIG. 4 is a front perspective view of a packing device according to some implementations.

FIG. 5 is a perspective view of a packing device as viewed obliquely from below according to some implementations.

FIG. 5A schematically illustrates a packing device having an outrunner/hub motor arrangement according to some implementations.

FIG. 5B schematically illustrates a packing device having timing pulley and belt system according to some implementations.

FIG. 6A-6D illustrate operation of a packing device according to some implementations.

FIGS. 7 and 8 illustrate a packer blade installed for motion in a chute according to some implementations.

FIG. 9 illustrates a sub assembly including a packer blade, connecting rod, and crank arm according to some implementations.

FIG. 10 is a detail view of a connection between a packer blade and a connecting rod.

FIG. 11 is a detail view illustrating the connection of the packer blade and the connecting rod.

FIG. 12 illustrates an example of a packing device having a packing blade with a guiding projection.

FIG. 12A illustrates a packer blade including a row of three snaggletooth projections spaced across a ramp surface of a packer blade.

FIG. 13 illustrates a detection device that can be used to determine the position of a packer blade according to some implementations.

FIG. 13A illustrates an alternate arrangement of components that can be used in some implementations.

FIG. 14 illustrates a waste collection device including an ejector system according to some implementations.

FIG. 15 illustrates a tailgate of a waste collection device according to some implementations.

FIG. 16 depicts an example of a control system for a vehicle including a packer system, according to implementations of the present disclosure.

FIG. 17 depicts an example computing system, according to implementations of the present disclosure.

### DETAILED DESCRIPTION

Implementations of the present disclosure are directed to systems, devices, and methods for collecting, packing, transporting, and disposing of refuse. Some implementations include an RCV with a reciprocating packing device and an ejector panel.

In various implementations, a waste collection system includes a reciprocating packing device. The reciprocating packing device includes a packing blade that is operated to move back and forth the pack waste. The packing blade can be driven by a drive unit that includes an electric motor. The packing device pushes the waste into a waste receiving volume of a storage container. The waste can be further compacted or ejected from the container by way of an eject system. The eject system can include an electrically driven ejector panel that is operated to push waste out of the container.

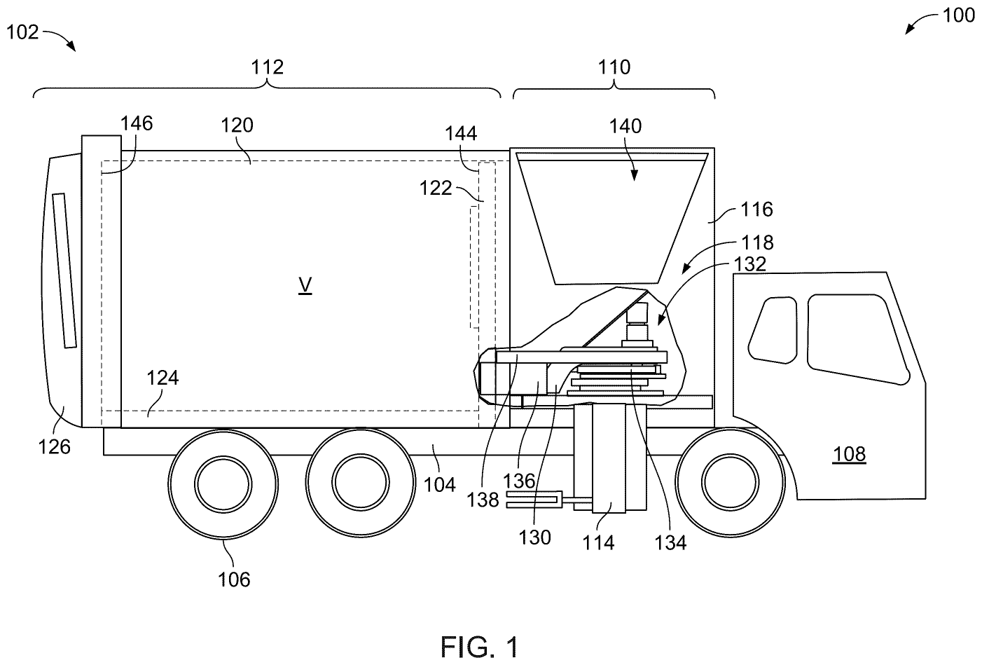

FIG. 1 is a refuse vehicle that includes a reciprocating packing device according to some implementations. Refuse vehicle 100 includes waste collection device 102, frame 104, wheels 106, and cab 108. Waste collection device 102 includes waste intake portion 110 and waste storage portion 112.

Waste intake portion 110 includes automatic loader 114, hopper 116, and packing device 118. Waste storage portion 112 includes container 120, ejector panel 122, ejector panel drive system 124, and tailgate assembly 126. The ejector panel 122, tailgate assembly and the walls of container 120 combine to define a waste receiving volume V of waste storage portion 112. Waste receiving volume V is partially defined by front wall 144 and rear wall 146.

Packing device 118 includes packer blade 130, drive unit 132, connecting rod 134, chute 136, and rails 138. Connecting rod 134 connects drive unit 132 to packer blade 130.

Packing device 118 can be operated to move packer blade 130 back and forth in chute 136 to pack waste introduced into waste intake portion 110.

In some implementations, automatic loader 114 is operated to load waste into hopper 116 by way of hopper opening 140. For example, automatic loader 114 can pick up residential-sized containers and tip them to dump the contents of the container into hopper 116.

Packing device 118 can receive waste introduced into hopper 116 and pack the waste into waste receiving volume V. Ejector panel drive system 124 can be operated to move ejector panel 122 rearward to eject or compact waste in waste receiving volume V.

Implementations may be employed with respect to any suitable type of RCV, with any suitable type of body and/or hopper variants. For example, the RCV may be an automated side loader vehicle. As another example, the RCV can be a commercial front loader (e.g., for dumpster type containers. As another example, the RCV can be a residential front loader. A front loader can be provided with or without an intermediate collection device. The intermediate collection device can be used, for example, to collect residential-sized containers.

Refuse vehicle 100 can be an RCV that operates to collect and transport refuse (e.g., garbage). The refuse collection vehicle can also be described as a garbage collection vehicle, or garbage truck. Refuse vehicle 100 can be configured to lift containers that contain refuse, and empty the refuse in the containers into a hopper of the refuse vehicle 100 and/or intermediate collection device conveyed by the RCV, to enable transport of the refuse to a collection site, compacting of the refuse, and/or other refuse handling activities. Refuse vehicle 100 can also handle containers in other ways, such as by transporting the containers to another site for emptying.

In some implementations, refuse vehicle 100 is an all-electric vehicle. Motive power and various body controls and sub-systems on the vehicle (including packing system, ejector system, door actuator system, and contamination detection systems) can be electrically powered.

Refuse vehicle 100 can include various components that are appropriate for the particular type of vehicle. For example, a garbage collection vehicle may be a truck with an automated side loader (“ASL”). Alternatively, the vehicle may be a front-loading truck, a rear loading truck, a roll off truck, or some other type of garbage collection vehicle. A vehicle with an ASL may include body components involved in the operation of the ASL, such as arms and/or a fork, as well as other body components such as a pump and so forth. A front-loading vehicle may include body components such as a hydraulic pump, grabber, and so forth. A rear loading vehicle may include body components such as a pump, blade, tipper, and so forth. A roll off vehicle may include body components such as a pump, hoist, cable, and so forth. Body components may also include other types of components that operate to bring garbage into a hopper (or other storage area) of a truck, compress and/or arrange the garbage in the hopper, and/or expel the garbage from the hopper.

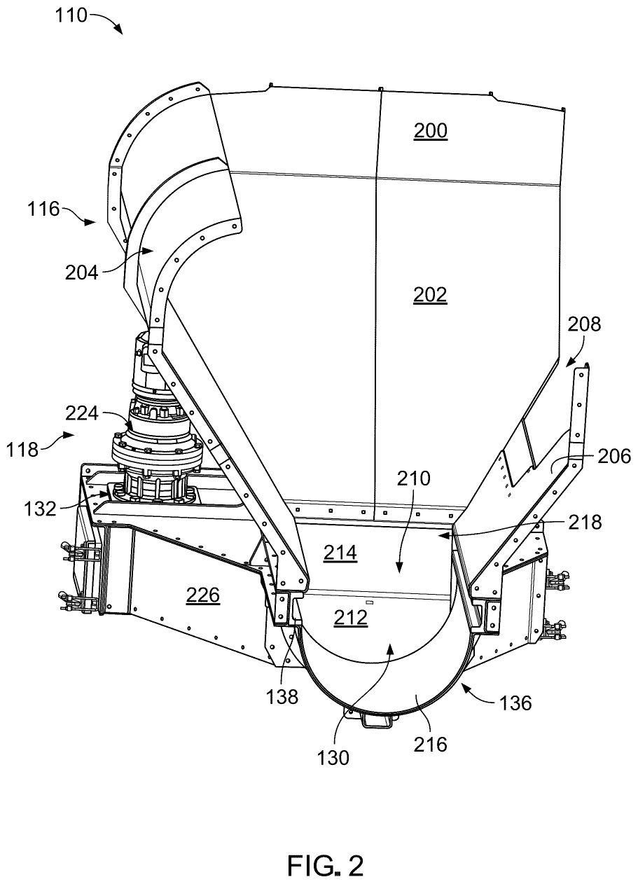

FIG. 2 is a rear perspective view of the waste intake portion of a waste collection device according to some implementations. (In this context, “rear” means viewed generally from the rear of a refuse vehicle on which the waste collection device is installed.) Waste intake portion 110 includes hopper 116 and packing device 118. Hopper 116 includes front panel 200, main panel 202, street-side panel 204, and curb-side panel 206. Side opening 208 is provided in curb-side panel 206. Bottom opening 210 is provided at the bottom of hopper 116.

Hopper 116 temporarily holds the waste before it reaches the packing device 118. Hopper 116 guides the waste toward the packing device 118 for subsequent packing.

Main panel 202, street-side panel 204, and curb-side panel 206 each include a sloping section. The sloping sections cooperate to form a collecting structure that funnels waste introduced into hopper 116 to bottom opening 210.

Packing device 118 includes packer blade 130, drive unit 132, chute 136, and rails 138. Drive unit 132 is operably connected to drive unit 132 by way connecting rod 134 (see FIG. 1). Drive unit 132 is operable to move packer blade 130 back and forth within chute 136.

Packer blade 130 is slidably connected to rails 138. In this example, packing device 118 is disposed between a pair of opposing rails 138. In other implementations, a packing device includes a packer blade that slides on only one rail or moves back and forth without be connected to a rail.

Packer blade 130 includes front surface 212 and sloping surface 214. Sloping surface 214 partially defines tapered leading portion of packer blade 130. Front surface 212 has a rounded bottom edge. Front surface 212 matches the shape of rounded bottom surface 216 of chute 136. When packer blade 130 is a retracted position in chute 136, the trailing edge of sloping surface 214 may align longitudinally with leading edge 218 of main panel 202.

Drive unit 132 includes motor assembly 224 and housing 226. Motor assembly 224 can rotate one or more components that move packer blade 130 back and forth in chute 136. Housing 226 includes a set of panels (e.g., sheet metal panels). The panels form a housing that protects the components of drive unit 132.

The example shown in FIG. 2, the waste intake system does not include an automatic loading device. A system such as the one shown in FIG. 2 can, however, in some implementations include an automatic loading device, such as automatic loader 114 shown in FIG. 1.

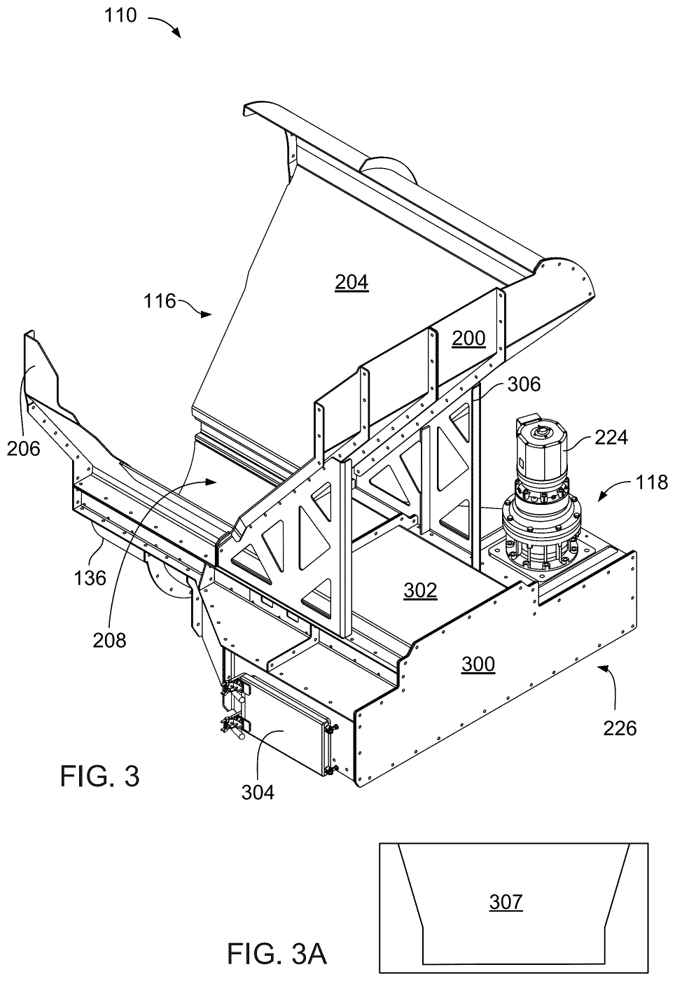

FIG. 3 is a front perspective view of the waste intake portion of a waste collection device according to some implementations. (In this context, “front” means viewed generally from the front of a refuse vehicle on which the waste collection device is installed.) Waste intake portion 110 includes hopper 116 and packing device 118. Hopper 116 includes front panel 200, main panel 202, street-side panel 204, and curb-side panel 206. Side opening 208 is provided in curb-side panel 206.

Housing 226 includes front panel 300, top panel 302, and access doors 304. Hopper 116 is supported on frame elements 306. Motor assembly 224 is secured by way of an attachment plate to housing 226. Front panel 300, top panel 302, and other portions of housing 226 protect components of packing device 118 from debris.

In various implementation described above, the chute has a curved bottom. A chute of a hopper can have other shapes. For example, the chute of a hopper can have a square bottom (see, e.g., chute 307 shown in FIG. 3A). In some implementations, a rectangular packer has rounded corners. The packer can extend up to the full width of the full width of the body.

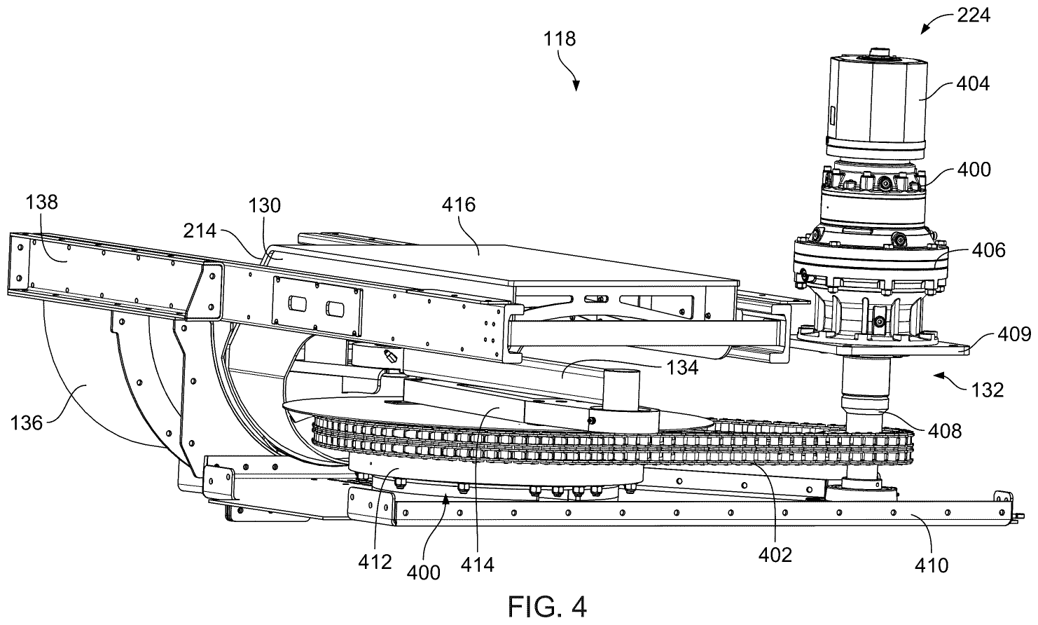

FIG. 4 is a front perspective view of a packing device according to some implementations. Packing device 118 includes packer blade 130, drive unit 132, connecting rod 134, chute 136, and rails 138. Packer blade 130 is slidably coupled to rails 138. Connecting rod 134 is pivotally coupled at one end to packer blade 130 and pivotally coupled at the other end to drive unit 132.

Drive unit 132 includes motor assembly 224, rotating assembly 400, and drive chain 402. Motor assembly 224 includes motor 404, gearbox 406, and shaft assembly 408. Motor assembly 224 is mounted to housing 226 (shown in FIG. 3) by way of mounting plate 409. Motor assembly 224 and rotating assembly 400 are secured to base member 410. Motor assembly 224 and rotating assembly 400 are coupled to one another by way of drive chain 402.

Rotating assembly 400 includes rotating component 412 and crank member 414. Crank member 414 is attached to the top of rotating component 412. Crank member 414 is pivotally connected to connecting rod 134. The pivot connection point between crank member 414 and connecting rod 134 is offset from the centerline of rotation of rotating component 412. As used herein, “rotating component” includes any component, or a combination of components, elements, or parts, that rotates or turns on an axis. Examples of a rotating component include a wheel, a bull gear, a bull sprocket, or a pulley. A rotating assembly includes an assembly that includes one or more rotating components.

Packer blade 130 includes upper surface 416. Upper surface 416 may guide waste and keep waste in hopper 116 until it is advanced by packer blade 130 through chute 136.

In some implementations, a packing device includes a brake. For example, drive unit 132 can include a brake that can be operated to stop packing blade at a particular position, such as the most extended position in container 120.

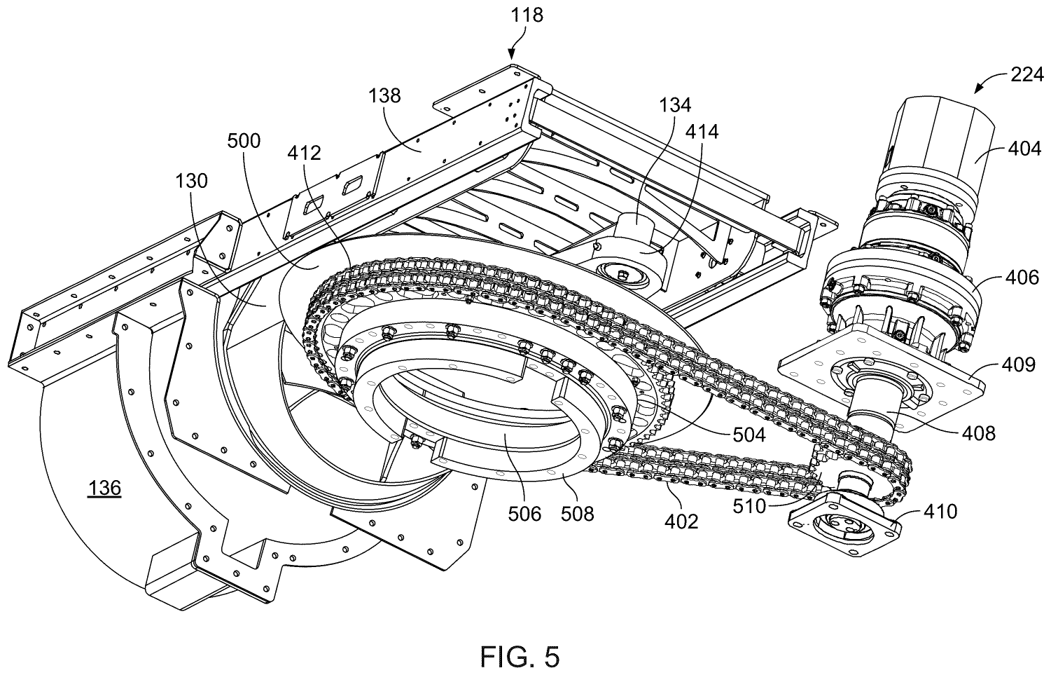

FIG. 5 is a perspective view of a packing device as viewed obliquely from below according to some implementations. Packing device 118 includes motor assembly 224 and rotating component assembly 400. Rotating assembly 400 includes rotating component 412 and crank member 414. Rotating component 412 includes main plate 500, sprocket 502, and bearing assembly 504. A cooperating bearing assembly 506 is coupled to base member 410 (shown in FIG. 4) by way of mounting ring 508. Drive sprocket 510 is provided on shaft assembly 408 of motor assembly 224. Motor assembly 224 is operably coupled to rotating assembly 400 by way of drive chain 402. Motor assembly 224 can be operated to turn rotating component assembly 400.

In the example shown in FIG. 5, a motor is connected by way of a chain drive. In other implementations, a drive unit can be connected to packing components in other manners, such as by a belt, a track, gears, rack-and-pinion, or a direct drive. A drive unit of a packing device may or may not include a chain or belt.

In the example shown in FIG. 5, rotating assembly includes a bull gear/sprocket. A packing device can, in other implementations, include other rotating components that turn to drive a packing mechanism. In some implementations, a drive unit of the packing device includes an outrunner/hub motor arrangement. In this implementation, the rotor of the electric motor is positioned outside the stator. FIG. 5A schematically illustrates a packing device having an outrunner/hub motor arrangement according to some implementations. Packing device 520 includes crank arm 522. Crank arm 522 is coupled to rotor 524 of electric motor assembly 526. Electric motor assembly 526 can be operated to turn crank arm 522 to move packer blade 528 back and forth to pack waste.

In other implementations of a packing device, the drive unit includes a timing pulley and belt system. FIG. 5B schematically illustrates a packing device having timing pulley and belt system according to some implementations. Packing device 540 includes crank arm 542. Crank arm 542 is coupled to timing pulley/belt system 544. Timing pulley/belt system 544 is coupled to motor assembly 546. Motor assembly 546 can be operated to turn crank arm 542 to move packer blade 548 back and forth to pack waste.

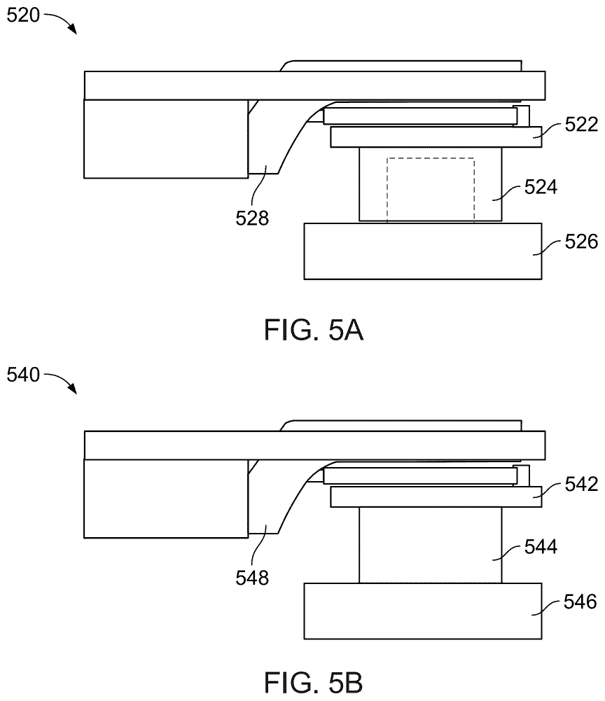

FIG. 6A-6D illustrate operation of a packing device according to some implementations. The packing device can be, for example, as described above relative to FIGS. 2-5. Initially, packer blade 130 is at the most retracted position in chute 136 (see FIG. 6A). Waste can be introduced onto packer blade 130 (for example, using hopper 116 shown in FIGS. 1-3.) Drive unit 132 is operated to turn rotating component 412. Crank member 414 turns to move connecting rod 134, thereby advancing packer blade 130 on rails 138 such that packer blade 130 advances in chute 136 (see FIG. 6B). As drive unit 132 continues to operate to turn rotating component 412, crank member 414 moves connecting rod 134 until packer blade 130 reaches is most extended position from chute 136 (see FIG. 6C). In this example, the leading edge of packer blade 130 is extended beyond ejector wall 122. As drive unit 132 continues to operate to turn rotating component 412, crank arm 414 draws connecting rod 134 such that packer blade 130 moves back in chute 136 (away from container 120 (see FIG. 6D). Packer blade 130 continues to move back in chute 136 until packer blade 130 returns to its most-retracted position (see again FIG. 6A).

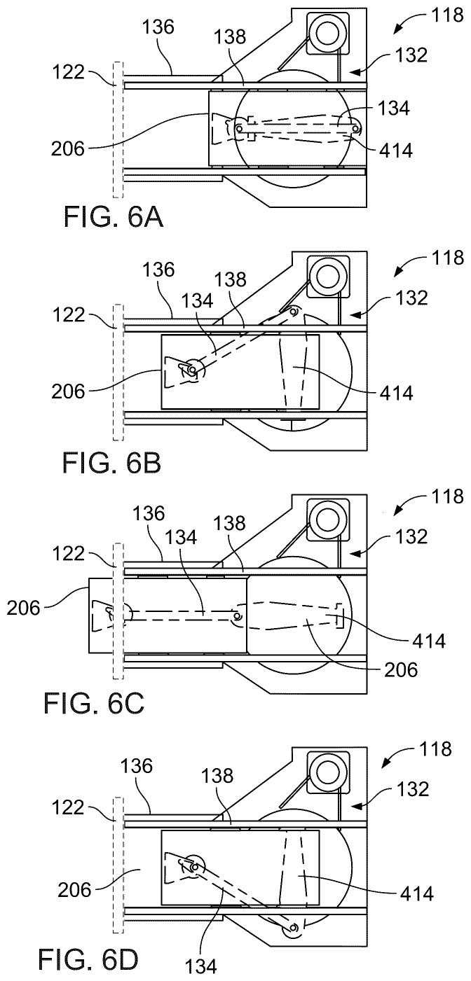

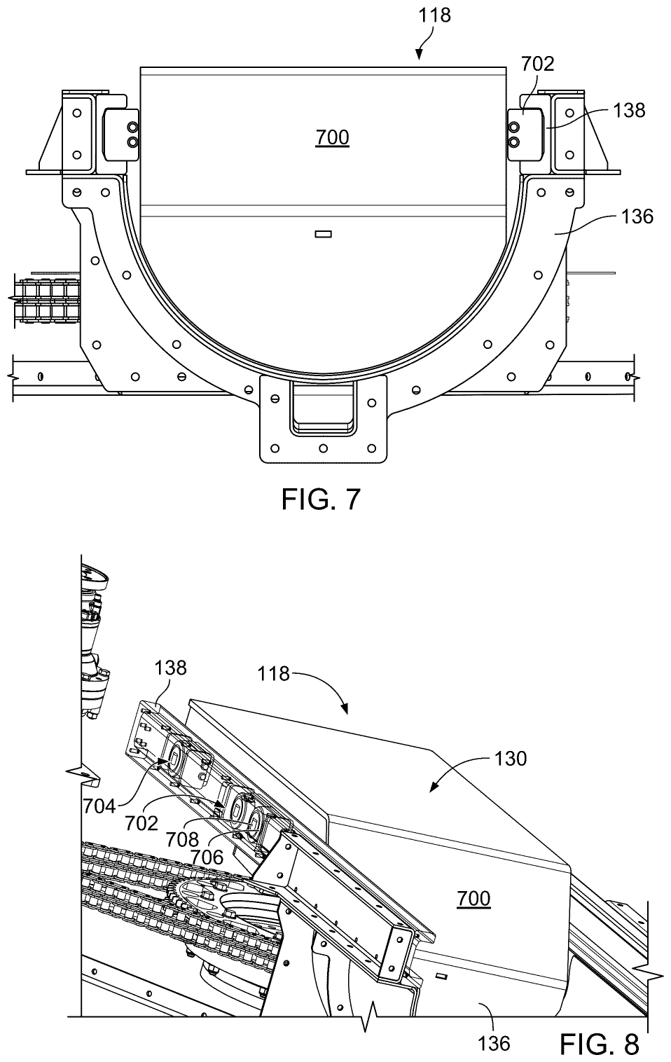

FIGS. 7 and 8 illustrate a packer blade installed for motion in a chute according to some implementations. In this example, the packer blade slides on a pair of opposing rails. Packer blade 130 can move forward and back in chute 136. Packer blade 130 includes body 700, rear bearing assemblies 702 and front bearing assemblies 704. Rear bearing assemblies 702 and front bearing assemblies 704 are secured to body 702. Each of rear bearing assemblies 702 includes two bearings 706 that engage the upper and lower legs of rails 138, and two bearings 708 that engage the sides of rails 138. Each of front bearing assemblies 704 includes one bearing 706 that engages the upper and lower legs of rails 138, and one bearing 708 that engages the sides of rails 138. Rear bearing assemblies 702 and front bearing assemblies 704 facilitate motion of packer blade 130 on rails 138.

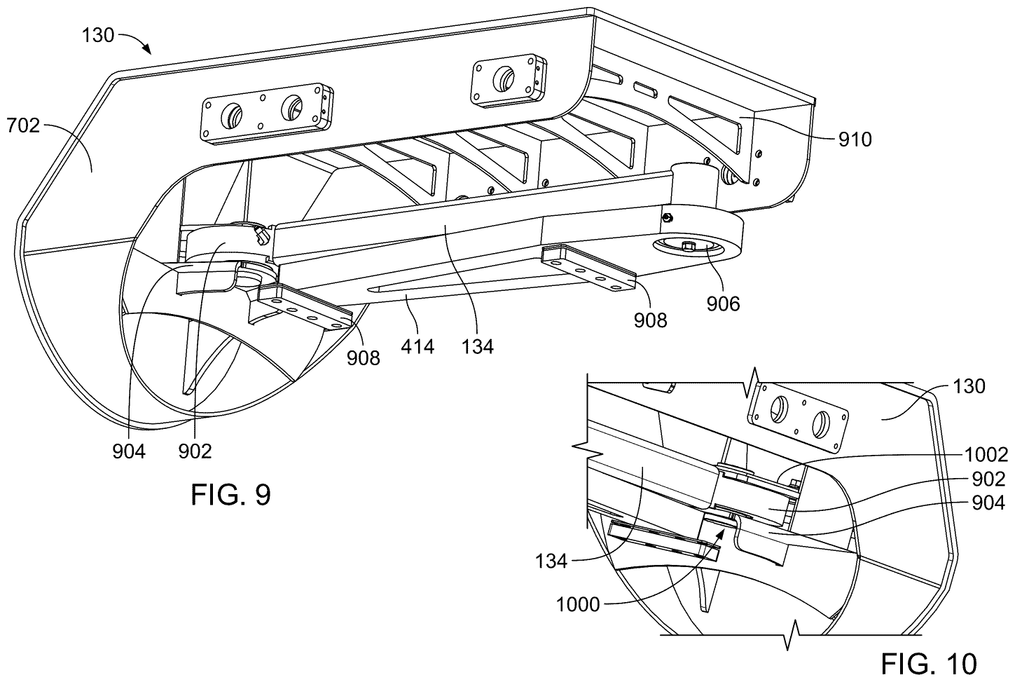

FIG. 9 illustrates a sub assembly including a packer blade, connecting rod, and crank arm according to some implementations. Connecting rod 134 is pivotally coupled to packer blade 130 at one end of connecting rod 134. Connecting rod 134 is pivotally coupled to crank arm 414 at the other end of connecting rod 134. Packer blade bearing assembly 902 is provided at the connection between packer blade 130 and connecting rod 134. Packer blade bearing assembly 902 is installed in clevis 904.

Crank arm bearing assembly 906 is provided at the connection between crank arm 414 and connecting rod 134. Two mounting blocks 908 are coupled to the bottom of crank arm 414. Mounting blocks 908 can be used to attach crank arm 414 to rotating component 412 (shown in FIGS. 4 and 5). Packer blade 130 includes ribs 910 on the underside of body 702 of packer blade 130. Ribs 910 provide reinforcement of body 702 of packer blade 130.

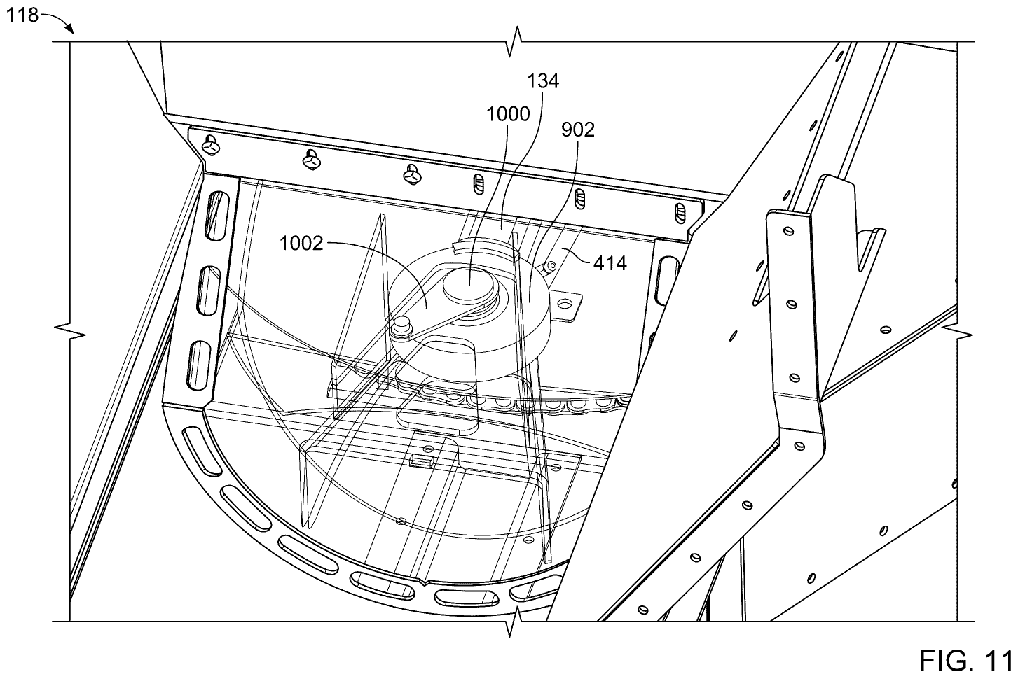

FIG. 10 is a detail view of a connection between a packer blade and a connecting rod. Pin 1000 retains packer blade bearing assembly 902 in clevis 910. Bar 1002 is coupled to packer blade 130 above clevis 904.

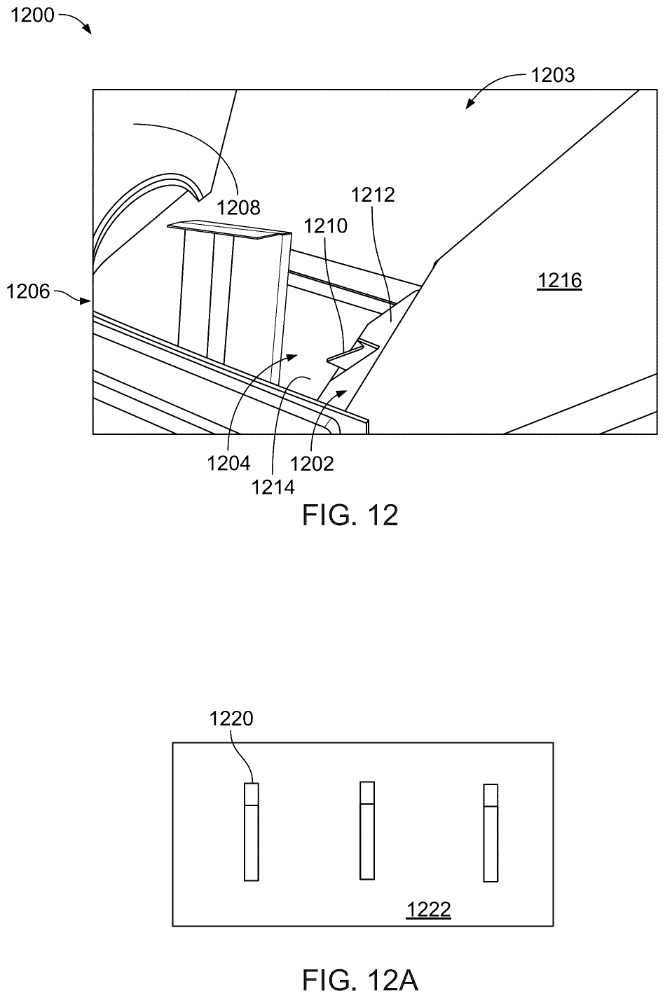

FIG. 11 is a detail view illustrating the connection of the packer blade and the connecting rod. In this example, connecting rod 134 includes a bearing assembly in a machined end housing. The end housing encloses packer blade bearing assembly 902. In some examples, packer blade bearing assembly 902 includes a spherical bearing. The spherical bearing can be greaseable and replaceable. Packer blade bearing assembly 902 is coupled to bar 1002. The bearing can support the pushing power of the connecting rod and slight pivoting movement of the packer blade during compaction of materials. Also, the rotation of the crank arm 414 may not always be parallel to the connecting rod and movement of the packer blade. The packing device may include connection that accommodates this difference in parallelism. For example, the packing device can include a spherical bearing on one end and conical bearing at the other end.

In some implementations, a packing device includes components that guide waste so that the waste does not impair operation of the packing device. For example, a packer can include projections or other guiding elements that inhibit trash from backing up a surface of a packer. Guiding elements can, for example, channel, deflect, block, or catch portions of the waste. In some implementations, guiding elements are included on one or more surfaces of a packer, such as a ramp or front panel of a packer blade.

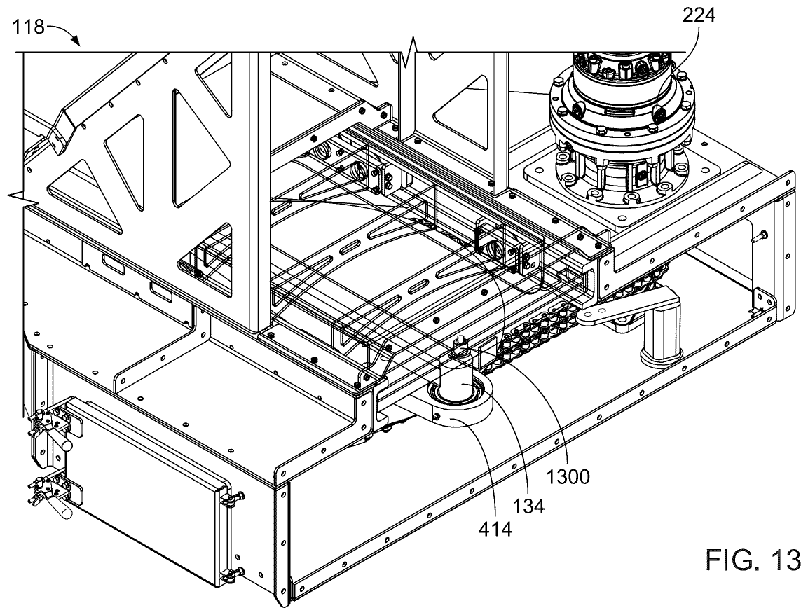

FIG. 12 illustrates an example of a packing device having a packing blade with a guiding projection. Packing device 1200 includes packer blade 1202 and hopper 1203. Packer blade 1202 can be driven by a drive unit to move back and forth in chute 1204. Packer blade 1202 can be operated to push material through opening 1206 in ejector wall 1208. Packer blade 1202 includes projection 1210 on a ramp 1212 of packer blade 1202. Projection 1210 may prevent trash from backing up on ramp 1212. In the example shown in FIG. 12, projection 1210 has a snaggletooth form. Projections can, however, be provided in other forms, such as spikes, ridges, or pins.

In the example shown in FIG. 12, only one projection is provided on the packer blade. In other implementations, a packer can include two or more projections. Elements that guide or control the movement of waste on a packer can be in forms than projections, such as a hooks or rods. FIG. 12A illustrates a packer blade including a row of three snaggletooth projections 1220 spaced across a ramp surface 1222 of a packer blade.

In some implementations, a packing device includes guards, panels, or other elements that guide or maintain waste in a position that the waste can be packed. For example, in the example shown in FIG. 12, floor 1214 below packer blade 1202 holds waste in front of packer blade 1202 so that the waste can be packed through opening 1206.

The packer blade can include panels that are arranged so that waste that drops in through the hopper falls onto the packer blade no matter how far extended the packer blade is in its range of motion. Thus, for example, as shown in FIG. 12, the trailing edge of packer blade 1202 may always be under main panel 1216 of hopper 1203 and behind the leading edge of main panel 1216, even when packer blade 1202 is at its most advanced position in chute 1204.

In some implementations, a waste collection system controls a packing device based on the position of one or more components of the packing device. For example, the waste collection system can control a packing device based on the position of a packer blade. In some instances, a waste collection system holds the packer blade at a fully extended position. In other instances, a waste collection system holds the packer blade at fully retracted position. The position, speed, or other characteristics of packing device components can be selected based on the mode of operation, conditions in the packer (for example, the amount, location, or type of collected material then present in the waste collection system), environmental conditions, or other characteristics.

In some implementations, the movement of the packer blade is stopped (for example, using a brake) in the extended position for ejection.

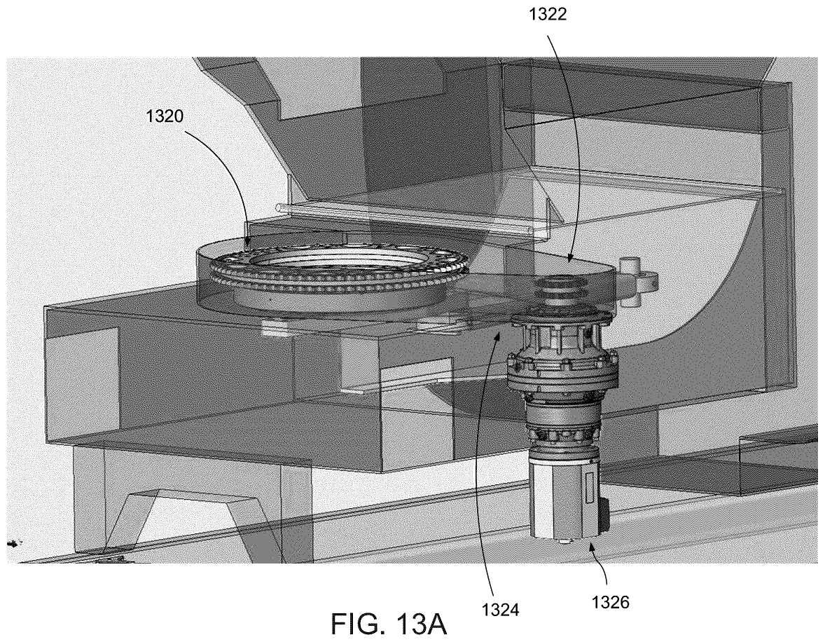

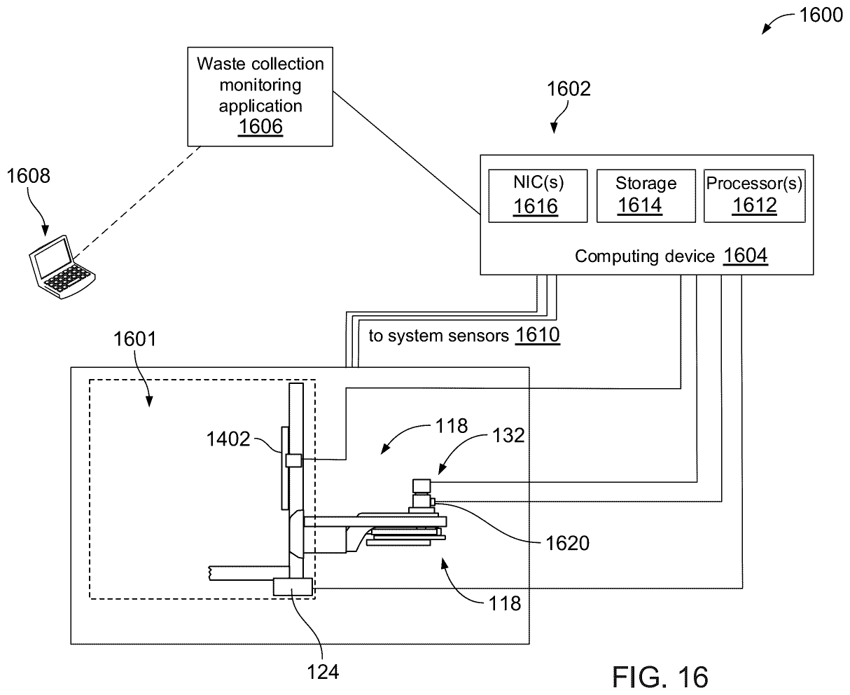

FIG. 13 illustrates a detection device that can be used to determine the position of a packer blade according to some implementations. Packing device 118 includes detection device 1300. Detection device 1300 can include, for example, a proximity switch. Detection device 1300 can detect the retracted position of the packer blade by detecting the end of connecting rod 134. Motor 404 can include an internal encoder. The detection device 1300 and/or the internal encoder can be operably connected to a controller (e.g., a control system as described below relative to FIG. 16). In some implementations, the overall ratio and data from the internal encoder of the electric motor are used to monitor the position of the packer blade.

FIG. 13A illustrates an alternate arrangement of components that can be used in some implementations. In FIG. 13A, rotating component 1320, drive chain (omitted for clarity), and drive sprocket 1322 are above crank member 1324. Drive unit 1326 is oriented upwardly. Thus, the components of the packer device show in FIG. 13A are generally inverted from that of, for example, FIG. 5. This implementation can, in some cases, reduce a risk of blockages caused by material becoming lodged between the chain and the large gear. In some implementations, a floor is included to separate the slew bearing from the connecting rod.

In some implementations, rotation is altered or adjusted based on a blockage in a waste collection system. For example, if there is a blockage in packing device 118, the speed of the rotation will change. In this case, the direction of the rotation can be reversed, and, accordingly, the movement of packer blade 130 can be reversed.

In some implementations, a packing device includes a braking device. The braking device can be operably coupled to a controller (such as the controller described relative to FIG. 16).

In other implementations, a brake on the electric motor is not included (for example, when sufficient information can be obtained from the overall ratio and having maximum force from the geometry at the fully extended position).

In some implementations, automatic packing is controlled when dumping materials. For example, the number of rotations can be varied with type of collection route. In one example, a recycling route might include more rotations than a garbage route. The speed of the motor and accordingly, the time cycle of the packer, can be adjusted. In one example, a system operates with unlimited clockwise rotation for compaction (for example, to reduce stress in the subfloor of the hopper box), and single counter-clockwise rotation maximum for blockage or manual operation.

In some implementations, a retry procedure is implemented if a blockage is encountered. As one example, a system can have two automatic retries after a blockage. In some implementations, reverse and/or boost mode operations can be performed to clear the blockage. If retry procedures are unsuccessful, other intervening measures can be performed (e.g., manually removing or agitating material), or waste collection operations can be discontinued or suspended.

When ejecting, it may take 2.5 rotations in order to empty the hopper and/or push as much material as possible into the body section.

In some implementation, a packing device is operated to move a packing blade to desired position before operation of an ejector panel system. For example, before the ejector ram retract, packer blade 130 can be retracted (0.5 rotation) in order to prevent any interference of leftover materials behind the ejector. In certain implementations, the packing device is operated to move a packer blade at the same time an ejector panel system is operating to move an ejector panel.

In some implementations, an RCV can operate in a transport mode. When the RCV is in transport mode, an automatic 0.5 rotation can be performed to extend the packer blade and block the tunnel entrance into the body. In this manner, materials can be prevented from flying away from the hopper.

In some implementations, torque is adjusted according to the packer blade position. In certain implementations, the torque of the motor, energy consumption, or other operating parameters are adjusted to account for different materials being collected. For example, operation of packing device for collecting recycled material can be different than operation of the packing device for collecting trash.

In some implementations, the system enters a boost mode if there is a blockage into the body (for example, to break the load). The boost mode may include changing motor rpm, torque, or both. The boost mode may allow to operator to finish a route and/or collect more materials.

In some implementations, a system has a slow rotation mode. The slow rotation mode can be used, for example, for cleaning, diagnostics, or greasing.

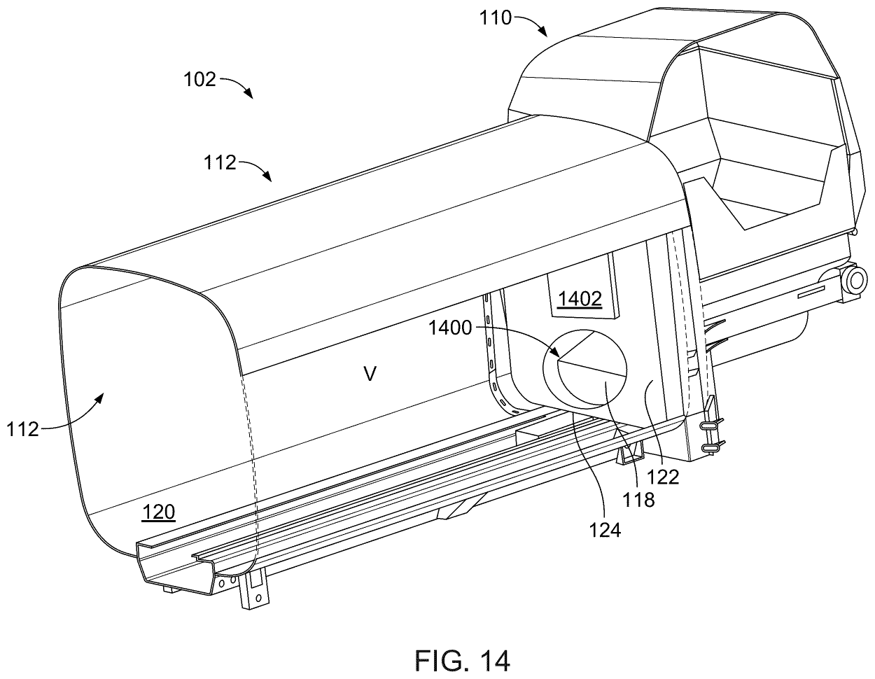

In some implementations, after a reciprocating packing device has been operated to advance waste into a waste receiving volume, an ejector panel system is operated to move eject from a refuse vehicle. FIG. 14 illustrates a waste collection device including an ejector system according to some implementations. Ejector panel 122 includes opening 1400. Packing device 130 can be operated to pack waste through opening 1400 into waste receiving volume V.

Ejector panel system 124 can be operated to move ejector panel along tracks to move waste out through the rear of container 120. In certain implementations, blocking device 1402 moved to cover opening 1400 before to inhibit waste from passing back through opening 1400 during operation of ejector panel system 124 to eject waste from container 120. The blocking device can be, for example, a sliding panel that moves up and down on vertical rails. The sliding panel can be operably coupled to a drive unit (e.g., a motorized drive unit that uses an electric motor to move blocking device 1402 to selectively block or reveal opening 1400).

The waste collection device 102 includes an ejector panel 122 for pushing the waste out of the container 120. The ejector panel 122 has a waste opening defined therethrough that registers with the waste opening defined through the front wall. The registering waste openings of the front wall and of the ejector panel 122 allow the waste to be inserted in the waste receiving volume V of the container 120 through both the first end wall and the ejector panel 122. The ejector panel 122 is movable along the longitudinal axis of the container between the front and rear ends and relative to the floor of the container 120. This movement of the ejector panel 122 pushes the waste toward the discharging opening of the container 120 and out of the waste receiving volume V via the opening.

In the embodiment shown, a footprint area of the ejector panel 122 corresponds substantially to an internal cross-sectional area of the container 120 taken perpendicularly to the longitudinal axis of the container. The footprint area might be slightly less than the internal cross-sectional area to allow the ejector panel 122 to move between the first and second ends without contacting the side walls. In one implementation, having the ejector panel 122 covering almost an entirety of the internal cross-sectional area allows all the waste to be pushed out of the container 120 in a unique pass, without requiring a plurality of passes of the ejector panel 122 within the container 120. Moreover, by being dimensioned as shown, the ejector panel 122 might prelude waste from escaping behind the panel via gaps between edges of the ejector panel and the side walls.

The waste opening of the ejector panel 122 can be blocked when emptying the container 120 to avoid waste from falling in a space located behind ejector panel 122. If that would occur, it might preclude the ejector panel 122 from going back to its original position. Therefore, the waste collecting device 10 includes a blocking device 1402.

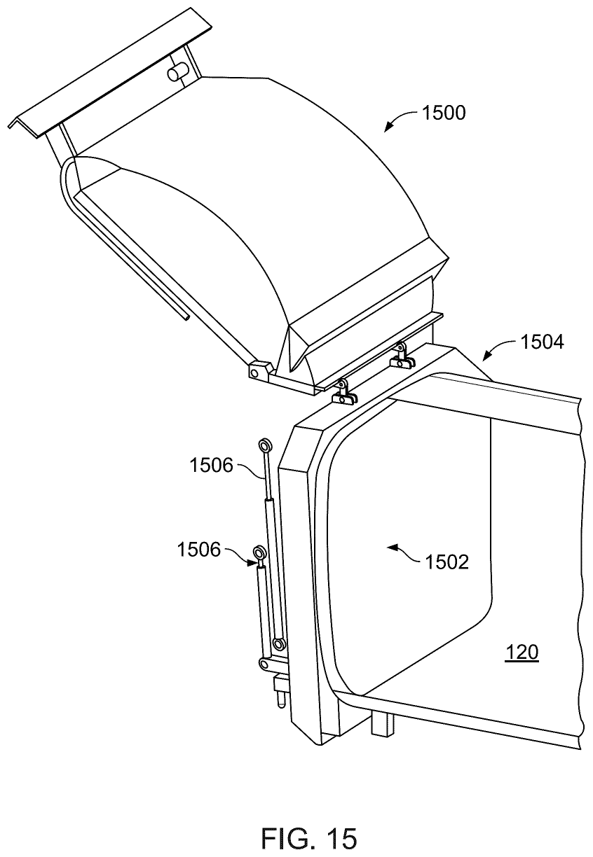

FIG. 15 illustrates a tailgate of a waste collection device according to some implementations. In this example, the rear wall 146 of container 120 is a door 1500 that is pivotally mounted to a remainder of the container 120 and that is used for closing a discharging opening 1502 of the container 120. More specifically, the door 1500 is pivotally mounted to a rear edge of the ceiling 1504 of the container 120. In the depicted embodiment, the door 1500 rotates about an axis of rotation that is perpendicular to the longitudinal axis of the container and perpendicular to the lateral walls of the containers. The door 1500 can be actuated using, for instance, hydraulic or electric actuators 1506. The door 1500 is pivotable between a closed position and an opened position. In the opened position, the door 1500 allows access to the waste receiving volume V for emptying the container 120. When filling the container 120, the door 1500 is usually in the closed position so that the waste is retained within the container 120.

In the waste collection device described above with respect to FIGS. 1-12, the packing device remains stationary while the ejector panel is moved toward the rear of the vehicle. In other implementations, the ejector panel is included on a frame that also carries the packing device. In such systems, the packing device may move with the ejector panel as the ejector panel is driven to the rear of the vehicle to compact or eject the refuse.

In various examples described above, a packer system includes a reciprocating blade. In some implementations, a packer system can include two or more packing blades. In certain implementations, a packer system includes an auger screw.

In various examples described above, a packer system includes a packing component that moves within a chute. In other implementations, a packing device can pack without any component to guide translation during the packing process.

In certain examples shown above, packing devices include use electric motor. Devices can, however, use other device of mechanisms, including, for example, linear actuators. In certain implementations, system can use hydraulic actuators.

Sensors can be included on various components of a waste collection system, including, for example, a packer blade, crank arm, or drive motor. A control system can be coupled to the packer sensors. In some implementations, a control system adjusts the packing device drive unit or the ejection panel drive system to achieve the desired forces on an ejector. A packer system can include other sensors. For example, a waste collection device can include additional load sensors, position sensors, angle sensors, or pressure sensors. Operation of the packer system can be controlled based on the information provided by the sensors. In some implementations, a packer system includes door sensors to sense position, angle, load or other characteristics about the system.

Control of a packing device may be carried out manually, automatically, or a combination thereof. In some implementations, a control system collects data from packer system sensors and/or other operational sensors and controls the packer system or other components of vehicle based on the information. For example, a control system may automatically shut down or reduce the speed of a drive system if a compression load (or another measured characteristic of the refuse vehicle's system) is outside an established range or exceeds an established threshold.

FIG. 16 illustrates a control system for a vehicle including a waste collection device, according to implementations of the present disclosure. System 1600 includes waste collection system and control system 1602. Control system 1602 includes computing device 1604, monitor application 1606, user device 1608, and sensors 1610.

The control system can include any number of sensors that sense loads, position, torque, angle, or other characteristics of the packer system or its components. The packer sensors may provide data during compaction, ejection, when the system is idle or shut down, or any other mode of operation. In some cases, sensors are used to obtain data about the operation of the drive system, such as operating temperature or pressure. Information from the sensors can be used to control motion of the ejector. For example, speed or acceleration of an ejector may be controlled based on loads encountered during packing, ejecting, or retracting.

Control system 1602 is operably coupled to drive unit 132 of packing device 118, braking device 1620, blocking device 1402, and eject panel drive system 124.

Computing device 1604 includes one or more processor(s) 1612, memory 1614, and network interface controller 1616. Memory 1614 provides data storage of suitable size and format. Network interface controller 1616 can facilitate communication of the computing device 1604 with other devices (for example, external monitoring devices and/or sensors) over one or more wired or wireless networks.

Computing device 1604 can provide notifications to an operator about conditions or maintenance of waste collection device. In some implementations, computing device 1604 provides notifications by way of monitor application 1606. Monitor application 1606 is coupled to user device 1608. User device 1608 can include a display that allows a user to view temperature and pressure readings, notifications, and other information.

In various implementations, control system 1602 controls components of a waste collection device based on information from sensors. For example, control system 1602 can control a drive unit of packing device 118 based on sensed torque or position.

In some implementations, a control system applies a brake device in response to sensor information about a position or a packing device component, the contents or condition of a container or hopper, or other sensed information. In one example, the control system applies a brake to stop a packing blade at the most extended position of the blade. In another example, the control system applies a brake to stop a packing blade at the most retracted state of the blade.

In some implementations, the packing system applies a constant packer force. For example, a constant RPM request with torque requests can be made that vary according to position of packer. As one example, low-torque to clear the hopper, then ramp torque request up as packer extends beyond the chute.

In some implementations, the packing system applies a variable speed. For example, action of arm will drive target RPM. In one example, a high collection rate can drive higher RPM on retract portion of stroke.

In some implementations, the packing system applies a proportional force. For example, a pure feedback where torque requested is proportional to load and packer position. In some implementations, there is a 1:1 relationship. Other ratios can, however, be used.

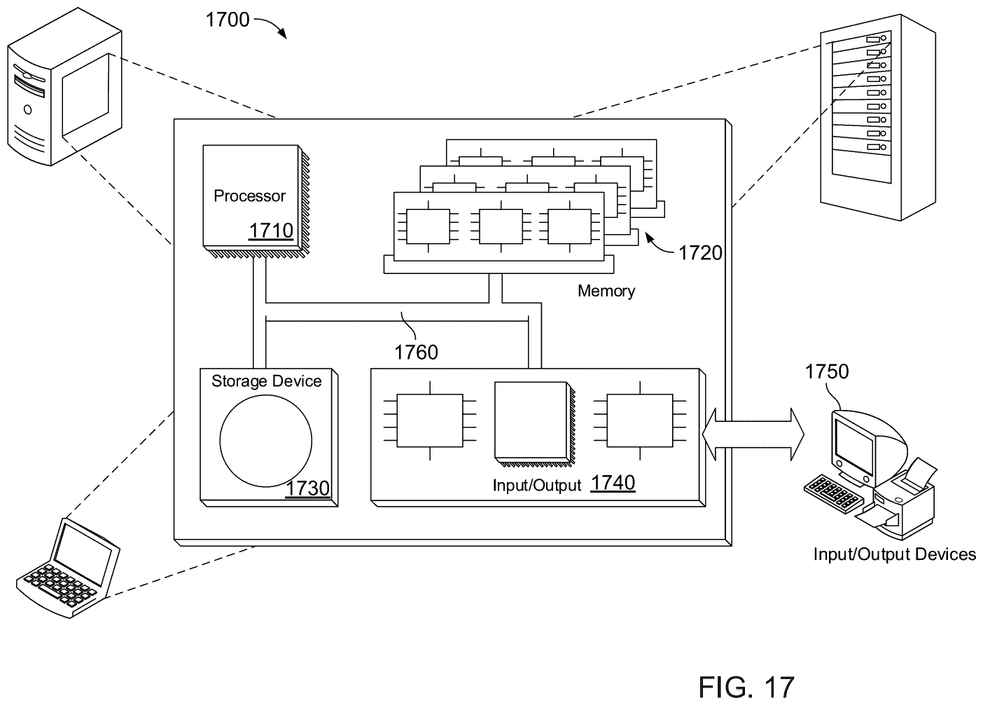

FIG. 17 depicts an example computing system, according to implementations of the present disclosure. The system 1700 may be used for any of the operations described with respect to the various implementations discussed herein. The system 1700 may include one or more processors 1710, a memory 1720, one or more storage devices 1730, and one or more input/output (I/O) devices 1750 controllable via one or more I/O interfaces 1740. The various components 1710, 1720, 1730, 1740, or 1750 may be interconnected via at least one system bus 1760, which may enable the transfer of data between the various modules and components of the system 1700.

The processor(s) 1710 may be configured to process instructions for execution within the system 1700. The processor(s) 1710 may include single-threaded processor(s), multi-threaded processor(s), or both. The processor(s) 1710 may be configured to process instructions stored in the memory 1720 or on the storage device(s) 1730. For example, the processor(s) 1710 may execute instructions for the various software module(s) described herein. The processor(s) 1710 may include hardware-based processor(s) each including one or more cores. The processor(s) 1710 may include general purpose processor(s), special purpose processor(s), or both.

The memory 1720 may store information within the system 1700. In some implementations, the memory 1720 includes one or more computer-readable media. The memory 1720 may include any number of volatile memory units, any number of non-volatile memory units, or both volatile and non-volatile memory units. The memory 1720 may include read-only memory, random access memory, or both. In some examples, the memory 1720 may be employed as active or physical memory by one or more executing software modules.

The storage device(s) 1730 may be configured to provide (e.g., persistent) mass storage for the system 1700. In some implementations, the storage device(s) 1730 may include one or more computer-readable media. One or both of the memory 1720 or the storage device(s) 1730 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 1700. In some implementations, the CRSM may include a data store that provides storage of computer-readable instructions or other information in a non-transitory format. The CRSM may be incorporated into the system 1700 or may be external with respect to the system 1700. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 1710 and the memory 1720 may be supplemented by, or incorporated into, one or more application-specific integrated circuits (ASICs). The system 1700 may include one or more I/O devices 1750.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

As used herein, a “packer” or “packing device” includes any device, mechanism, or system that packs, pushes, or compacts material in a compartment or ejects material from a compartment.

As used herein, an “ejector” includes any component or combination of components that can be used to push material to compact the material or eject the material from a compartment or vessel. As one example, an ejector may be a metal plate that collects and moves refuse as the ejector is moved within a storage compartment.

As used herein, a “drive unit” includes any device, mechanism, or system that imparts force to mechanically drive one or more components. Examples of a drive unit include a hydraulic motor, an electric motor, or an engine. A driver may also include gearboxes, belts, chain drives, or other power transmission devices.

As used herein, a “blade” includes any component or combination of components that has one or more panels or other structures that can push material from one place to another. A packer blade can be, for example, a panel, a plate, a spade, a piston, a shovel, a cup, a plunger, or a combination of one or more of such elements. In some implementations, a packing device can have other packing components that push material instead of, or in addition to, a packer blade.

A chute can be any of various suitable forms for accommodating the passage of material. Examples of a chute include a tube, a channel, or a tunnel. A chute can be closed (such as a tunnel) or open (such as a half-pipe).

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

1. A waste packing device comprising:
a chute comprising an opening;
a packer blade configured to translate back and forth in the chute;
a rod pivotally coupled to the packer blade; and
a drive unit pivotally coupled to the rod and operable to move the packer blade back and forth in the chute to push waste through the opening of the chute.

2. The packing device of claim 1, wherein the packer blade is operable to advance waste from the chute into a container for receiving waste.

3. The packing device of claim 1, further comprising a hopper configured to direct waste onto the packer blade.

4. The packing device of claim 1, wherein the packer blade is configured to extend beyond the chute.

5. The packing device of claim 1, wherein the chute comprises a curved bottom portion or a square bottom portion.

6. The packing device of claim 1, wherein:
the rod comprises a first end and a second end,
the first end of the rod is coupled to the packer blade and the second end of the rod is coupled to the drive unit.

7. The packing device of claim 1, wherein:
the drive unit comprises a rotating component, and
an electric motor coupled to the rotating component.

8. The packing device of claim 1, wherein:
the drive unit comprises a rotating component; and
one end of the rod is pivotally coupled to the rotating component at a pivot point offset from a rotation axis of the rotating component, and
wherein the rotating component comprises a bull sprocket.

9. The packing device of claim 1, wherein:
the drive unit comprises:
a drive motor; and
a rotating component pivotally coupled to a first end of the rod;
a drive chain operably coupled between the motor and rotating component, and
the motor is operable to turn the rotating component to move the packer blade back and forth in the chute.

10. The packing device of claim 1, wherein:
the drive unit comprises an outrunner/hub motor system; and
the outrunner/hub motor system comprises a rotating component configured to move the packer blade back and forth in the chute.

11. The packing device of claim 1, wherein:
the drive unit comprises a timing belt and pulley system; and
the timing belt and pulley system comprises a rotating component configured to move the packer blade back and forth in the chute.

12. The packing device of claim 1, further comprising a controller coupled to the drive unit, wherein the controller is operable to control the drive unit to move the packer blade forward and back in the chute.

13. The packing device of claim 12, wherein the controller is configured to control the motor to selectively hold the packer blade in a fixed position in the chute.

14. The packing device of claim 12, wherein the controller is configured to control the motor to hold the packer blade a forward-most position in the chute.

15. The packing device of claim 1, further comprising a brake configured to hold the packer blade in a selected position in the chute.

16. The packing device of claim 15, wherein the brake is a motor brake.

17. The packing device of claim 1, further comprising:
a brake configured to hold the packer blade in a selected position in the chute; and
a controller coupled to the brake and configured to apply the brake to hold the packer blade in a selected position in the chute.

18. The packing device of claim 1, wherein:
the packer blade comprises:
a leading portion comprising a leading end; and
a trailing portion, and
the leading portion comprises a sloping nose section configured to direct waste toward the leading end of the packer blade.

19. The packing device of claim 1, further comprising one or more guide rails, wherein the packer blade is slidably coupled to at least one of the one or more guide rails.

20. The packing device of claim 19, wherein the one or more guide rails comprise a pair of opposing guide rails, wherein the packer blade is slidably coupled between the pair of opposing guide rails.

21. The packing device of claim 1, further comprising:
a container configured to receive waste pushed through the chute by the packer blade; and
an ejector panel configured to push waste out of the container.

22. The packing device of claim 1, wherein the packer blade comprises one or more projections on a surface of the packer blade configured to inhibit waste from backing up on a ramp of the packer blade.

23. The packing device of claim 1, wherein the packer blade comprises two or more projections on a surface of the packer blade.

24. The packing device of claim 1, wherein the packer blade comprises two or more projections on a surface of the packer blade, wherein at least one of the projections is a snaggletooth projection.

25. A vehicle for collecting waste, the vehicle comprising:
a frame; and
a waste collecting device secured to the frame, the waste collecting device comprising:
a container enclosing a waste receiving volume, and
a packing device coupled to the container, the packing device comprising:
a packer blade configured to translate back and forth;
a rod pivotally coupled to the packer blade; and
a drive unit pivotally coupled to the rod and operable to move the packer blade back and forth to push waste into the waste receiving volume.

26. The vehicle for collecting waste of claim 25, further comprising a hopper configured to direct waste onto the packer blade.

27. The vehicle for collecting waste of claim 25, further comprising a chute, wherein the packer blade is configured to translate back and forth in the chute to push waste through an opening in the chute into the waste receiving volume.

28. The vehicle for collecting waste of claim 25, wherein:
the container comprises:
a first end and a second end spaced apart from the first end along a longitudinal axis,
an end wall located at the first end; and
an ejector panel located at the second end,
the waste receiving volume is defined by a space between the end wall and the ejector panel, and
the ejector panel is configured to push waste through and out of the waste receiving volume during an unloading sequence by moving along the longitudinal axis between the first and second ends within the waste receiving volume and relative to a floor of the container.

29. The vehicle for collecting waste of claim 28, further comprising a blocking device coupled to the ejector panel and configured to move along a direction perpendicular to the longitudinal axis between a first position, in which the blocking device inhibits waste in the waste receiving volume from entering the opening as the ejector panel moves along the longitudinal axis, and a second position, in which waste is uninhibited from entering the waste receiving volume through the opening.

30. A method of packing waste, comprising:
receiving waste onto a packer blade; and
moving the packer blade forward and back to push the waste into a waste receiving container.

31. The method of claim 30, wherein moving the packer blade comprises moving the packer blade forward and back within a chute.

32. The method of claim 30, wherein moving the packer blade comprises operating an electric motor to turn a rotating component coupled to packer blade.

33. The method of claim 30, further comprising:
taking one or more measurements relating to the motion of the packer blade,
in response to at least one of the one or more measurements, controlling one or more operating parameters of the packer blade.

34. The method of claim 33, wherein controlling at least one of the operating parameters comprises controlling a speed of the packer blade.

35. The method of claim 33, wherein controlling at least one of the operating parameters comprises controlling a speed of an electric motor.

36. The method of claim 33, wherein controlling at least one of the operating parameters comprises controlling a position of the packer blade.

37. The method of claim 33, wherein controlling at least one of the operating parameters comprises controlling an angular position of a rotating component coupled to the packer blade.

38. The method of claim 33, wherein taking one or more measurements comprises measuring a torque of a drive component for the packer blade.

39. The method of claim 33, wherein taking one or more measurements comprises measuring a position of the packer blade or the position of one or more components coupled to the packer blade.

40. The method of claim 33, further comprising, in response to one or more measurements, stopping the packer blade.

41. The method of claim 33, further comprising applying a brake to inhibit motion of the packer blade.

42. The method of claim 33, wherein controlling at least one of the operating parameters comprises applying a constant torque to a drive rotating component.
